(19) United States
(12) Patent Application Publication
(10) Pub. No.: US 2021/0201073 A1
(43) Pub. Date: Jul. 1, 2021

(54) IMAGE ENCODING METHOD AND DEVICE AND COMPUTER-READABLE STORAGE MEDIUM

(71) Applicant: SZ DJI TECHNOLOGY CO., LTD., Shenzhen (CN)

(72) Inventors: Wenjun ZHAO, Shenzhen (CN); Hengjie LI, Shenzhen (CN)

(73) Assignee: SZ DJI TECHNOLOGY CO., LTD., Shenzhen (CN)

(21) Appl. No.: 17/201,155

(22) Filed: Mar. 15, 2021

Related U.S. Application Data
(63) Continuation of application No. PCT/CN2019/075762, filed on Feb. 21, 2019.

(51) Int. Cl. G06K 9/62; G06T 9/00; G06K 9/46; H04N 19/124

(52) U.S. Cl. CPC G06K 9/6227; G06T 9/00; H04N 19/124; G06K 9/6256; G06K 9/4604

(57) ABSTRACT

Embodiments of the present disclosure provide an image encoding method and device, and a computer-readable storage medium. The method includes: obtaining a to-be-encoded image set, where the to-be-encoded image set includes at least one to-be-encoded image; extracting feature information of each to-be-encoded image by using a preset feature extraction model, to obtain image feature information; determining an encoding parameter corresponding to the image feature information; and sending the encoding parameter to an image encoder, so that the image encoder performs an encoding operation on the to-be-encoded image based on the encoding parameter. Therefore, the to-be-encoded image can be automatically encoded, image encoding efficiency is effectively improved, and human resources can be saved.

### RELATED APPLICATIONS

This application is a continuation application of PCT application No. PCT/CN2019/075762, filed on Feb. 21, 2019, and the content of which is incorporated herein by reference in its entirety.

### TECHNICAL FIELD

Embodiments of the present disclosure relate to the image processing field, and in particular, to an image encoding method and device, and a computer-readable storage medium.

### BACKGROUND

Image information usually includes a lot of redundant information, image encoding needs to be performed on the image information when a digital method is used for transmission or storage. Image encoding, also known as image compression, is a technology that uses a smaller quantity of bits to represent an image or information included in an image under certain quality conditions.

Conventional image encoding is generally implemented by an image encoder. Because there are often differences between different images, there are also differences between different image features. When image encoding is performed by an image encoder, encoding personnel need to manually extract the features of different images, and adjust parameters based on the extracted features.

However, when the foregoing method is used for image encoding, on the one hand, essential features of an image cannot be directly extracted in a feature extraction process. On the other hand, the foregoing method usually requires high professional quality of encoding personnel, and both feature extraction and parameter determination are manually implemented. Thus, the manual implementation is laborious and time-consuming, resulting in low image encoding efficiency.

### SUMMARY

Embodiments of the present disclosure provide an image encoding method and device, and a computer-readable storage medium.

A first aspect of the present disclosure provides an image encoding method, including: obtaining a to-be-encoded image set, where the to-be-encoded image set includes at least one to-be-encoded image; for a to-be-encoded image of the at least one to-be-encoded image: extracting image feature information of the to-be-encoded image using a preset feature extraction model; determining an encoding parameter corresponding to the image feature information; and sending the encoding parameter to an image encoder to encode the to-be-encoded image based on the encoding parameter.

A second aspect of the present disclosure provides an image encoding device, including: at least one memory storing a set of instructions for image encoding; and at least one processor in communication with the at least one memory, where during operation, the at least one processor executes the set of instructions to: obtain a to-be-encoded image set, where the to-be-encoded image set includes at least one to-be-encoded image; for a to-be-encoded image of the at least one to-be-encoded image: extract image feature information of each the to-be-encoded image using a preset feature extraction model; determine an encoding parameter corresponding to the image feature information; and send the encoding parameter to the image encoder to encoding the to-be-encoded image based on the encoding parameter.

A third aspect of the present disclosure provides non-transitory computer-readable storage medium, where the computer-readable storage medium stores a set of instructions for image encoding; and where when executed by at least one processor, the set of instruction direct the at least one processor to perform: obtaining a to-be-encoded image set, where the to-be-encoded image set includes at least one to-be-encoded image, for a to-be-encoded image of the at least one to-be-encoded image: extracting image feature information of the to-be-encoded image using a preset feature extraction mode, determining an encoding parameter corresponding to the image feature information, and sending the encoding parameter to an image encoder to encoding the to-be-encoded image based on the encoding parameter.

Embodiments of the present disclosure provide an image encoding method and device, and a computer-readable storage medium. A to-be-encoded image set is obtained, where the to-be-encoded image set includes the at least one to-be-encoded image; the feature information of each to-be-encoded image is extracted by using the preset feature extraction model, to obtain the image feature information; the encoding parameter corresponding to the image feature information is determined; and the encoding parameter is then sent to the image encoder, so that the image encoder may perform the encoding operation on the to-be-encoded image based on the encoding parameter. Therefore, the to-be-encoded image can be automatically encoded, image encoding efficiency is effectively improved, and human resources can be saved.

### BRIEF DESCRIPTION OF THE DRAWINGS

To describe the technical solutions in the embodiments of the present disclosure more clearly, the following briefly describes the accompanying drawings required for describing the embodiments. Apparently, the accompanying drawings in the following description show some exemplary embodiments of the present disclosure, and a person of ordinary skill in the art may still derive other drawings from these accompanying drawings without creative efforts.

FIG. 1 is a schematic flowchart of an image encoding method according to some exemplary embodiments of the present disclosure;

FIG. 2 is a schematic flowchart of an image encoding method according to some exemplary embodiments of the present disclosure;

FIG. 3 is a schematic flowchart of an image encoding method according to some exemplary embodiments of the present disclosure;

FIG. 4 is a schematic flowchart of an image encoding method according to some exemplary embodiments of the present disclosure;

FIG. 5 is a schematic flowchart of an image encoding method according to some exemplary embodiments of the present disclosure; and

FIG. 6 is a schematic structural diagram of an image encoding device according to some exemplary embodiments of the present disclosure.

### DETAILED DESCRIPTION

The following describes the technical solutions in some exemplary embodiments of the present disclosure with reference to the accompanying drawings of the exemplary embodiments of the present disclosure. Apparently, the described exemplary embodiments are merely some but not all of the embodiments of the present disclosure. All other embodiments obtained by persons of ordinary skill in the art based on the embodiments of the present disclosure without creative efforts shall fall within the protection scope of the present disclosure.

It should be noted that when a component is described as “fixed” to another component, the component may be directly located on another component, or an intermediate component may exist therebetween. When a component is considered as “connected” to another component, the component may be directly connected to another element, or an intermediate element may exist therebetween.

Unless otherwise defined, meanings of all technical and scientific terms used in the disclosure are the same as those generally understood by a person skilled in the art. The terms used in the present disclosure are only to describe the specific embodiments, and not intended to limit the present disclosure. The term “and/or” used in this specification includes any or all possible combinations of one or more associated listed items.

The following describes in detail some exemplary embodiments of the present disclosure with reference to the accompanying drawings. In absence of conflicts, the following embodiments and features in the embodiments may be combined.

Conventional image encoding is generally implemented by an image encoder. There are often differences between different images; there are also differences between different image features. When image encoding is performed by an image encoder, encoding personnel need to manually extract the features of different images, and then adjust parameters based on the extracted features. However, when the foregoing method is used for image encoding, on the one hand, essential features of an image cannot be directly extracted in a feature extraction process. On the other hand, the foregoing method usually requires high professional quality of encoding personnel, and both feature extraction and parameter determination are manually implemented. The manual implementation is laborious and time-consuming, resulting in low image encoding efficiency. To resolve the foregoing technical problems, the present disclosure provides an image encoding method and device, and a computer-readable storage medium.

It should be noted that the image encoding method and device and the computer-readable storage medium provided by the present disclosure can be applied to any image encoding scenario.

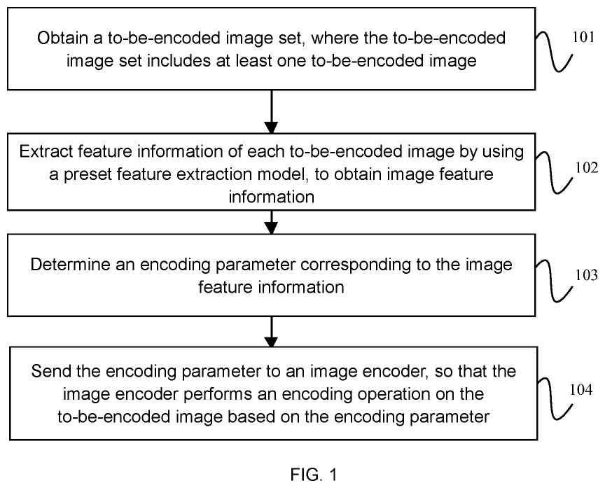

FIG. 1 is a schematic flowchart of an image encoding method according to some exemplary embodiments of the present disclosure. As shown in FIG. 1, the method includes the following steps.

Step 101: Obtain a to-be-encoded image set, where the to-be-encoded image set includes at least one to-be-encoded image.

Step 102: Extract feature information of each to-be-encoded image by using a preset feature extraction model, to obtain image feature information.

Step 103: Determine an encoding parameter corresponding to the image feature information.

Step 104: Send the encoding parameter to an image encoder, so that the image encoder performs an encoding operation on the to-be-encoded image based on the encoding parameter.

In some exemplary embodiments, to encode the to-be-encoded image, features of the to-be-encoded image need to be extracted first. Specifically, the to-be-encoded image set may be obtained, and the to-be-encoded image set includes at least one to-be-encoded image. To extract the image feature information of the to-be-encoded image, the feature extraction model may be established first. After the to-be-encoded image set is obtained, the to-be-encoded image in the to-be-encoded image set is added to the preset feature extraction model. The features of the to-be-encoded image are then extracted by using the feature extraction model, to obtain the image feature information corresponding to the to-be-encoded image. It should be noted that extraction of the image feature information by using the preset feature extraction model can effectively improve the accuracy and efficiency of feature extraction, and avoid problems of inaccurate feature extraction and human resource consumption caused by manual extraction of features of a to-be-encoded image. It is understood that since image feature information corresponding to similar images is similar, image encoding can be performed on similar images by using a same encoding parameter. Therefore, at least one similar image cluster may be determined first. For each similar image cluster, an encoding parameter corresponding to the image cluster may be preset for the image cluster. An optimum encoding effect can be achieved by using the encoding parameter. Further, after the image feature information corresponding to the to-be-encoded image is obtained, an image cluster to which the image feature information belongs is determined first, and subsequently, an encoding parameter corresponding to the image feature information may be determined based on a preset correspondence between an image cluster and an encoding parameter. After the encoding parameter corresponding to the image feature information is determined, the encoding parameter may be sent to the image encoder, so that the image encoder can perform image encoding on the to-be-encoded image based on the encoding parameter. Because the optimum encoding effect can be achieved by performing encoding based on the encoding parameter, encoding accuracy can be improved on the basis of improving image encoding efficiency.

In the image encoding method provided by some exemplary embodiments, a to-be-encoded image set is obtained, where the to-be-encoded image set includes the at least one to-be-encoded image; the feature information of each to-be-encoded image is extracted by using the preset feature extraction model, to obtain the image feature information; the encoding parameter corresponding to the image feature information is determined; and the encoding parameter is then sent to the image encoder, so that the image encoder may perform the encoding operation on the to-be-encoded image based on the encoding parameter. Therefore, the to-be-encoded image can be automatically encoded, image encoding efficiency is effectively improved, and human resources can be saved.

Further, on the basis of the foregoing exemplary embodiments, prior to the extracting of the feature information of the to-be-encoded image by using a preset feature extraction model, the method may further include:

Training a preset to-be-trained model by using a preset to-be-trained image set, to obtain the feature extraction model.

Generally, in a conventional image encoding method, encoding personnel manually extract features of different images. However, an essential feature(s) of an image usually may not be directly extracted in a process of manually extracting features of a to-be-encoded image, and significant human resources may be consumed. Therefore, in some exemplary embodiments, to improve accuracy of feature extraction and save human resources, the feature extraction model may be established beforehand, and the features of the to-be-encoded image are then extracted by using the feature extraction model. Therefore, firstly a to-be-trained model may be established, and then the to-be-trained model is trained by using a preset to-be-trained image set, to obtain the feature extraction model. The to-be-trained model may be a deep convolutional neural network (for example, Visual Geometry Group Net, VGGNet for short). The VGGNet may have a plurality of different structures, such as a VGG-16 model and a VGG-19 model, where the VGG-16 model is a 16-layer deep convolutional neural network, and the VGG-19 model is a 19-layer deep convolutional neural network. In some exemplary embodiments of the present disclosure, the VGG-16 model may be specifically used as the to-be-trained model. It should be noted that the VGG-16 model has high network performance, a low feature extraction error rate, and high scalability. Specifically, the to-be-trained image set may be randomly divided into a training set, a test set, and a verification set. The to-be-trained model is trained by using the training set, an output result of the to-be-trained model is tested by using the test set, and an output result of the to-be-trained model is verified by using the verification set. Iterative training is performed on the to-be-trained model until the to-be-trained model converges, and the feature extraction model is obtained. In addition, another type of convolutional neural network may also be used as the to-be-trained model. This is not limited in the present disclosure.

In the image encoding method provided by some exemplary embodiments, the preset to-be-trained model is trained by using the preset to-be-trained image set to obtain the feature extraction model, so that the feature extraction model can implement feature extraction of the to-be-encoded image, thereby improving accuracy of feature extraction and saving human resources, and providing a basis for improving accuracy of image encoding.

It should be noted that the to-be-trained image set may specifically include an image texture dataset and a real image dataset. Any dataset including texture images can be an image texture dataset. For example, the dataset may be a Flickr Material Dataset (FMD), or a Describable Texture Dataset (DTD). In some exemplary embodiments of the present disclosure, the Describable Texture Dataset may be specifically used. This dataset may be divided into 47 categories, and each category may have 120 images. In a practical training process, the image texture dataset may be randomly divided into training sets, test sets, and verification sets according to a preset ratio. Specifically, the preset ratio may be 8:1:1, or any other ratio that may implement model training. This is not limited in the present disclosure.

Correspondingly, the training of the preset to-be-trained model by using the preset to-be-trained image set may include:

Training the to-be-trained model by using the image texture dataset, to obtain a first model; and

Training the first model by using the real image dataset, to obtain the feature extraction model.

In some exemplary embodiments, after the to-be-trained image set is obtained, the to-be-trained model may be trained by using the to-be-trained image set, so that the to-be-trained model may have a feature extraction function. Specifically, the to-be-trained model may be firstly trained preliminarily by using the image texture dataset in the to-be-trained image set, to obtain the first model. Because the image texture dataset includes a plurality of images containing texture information, the first model obtained through the training by using the image texture dataset may effectively identify and extract feature information. However, in an actual application process, the to-be-encoded image may be any type of image, not only including a texture image, to enable the first model to extract features of any type of image, the first model needs to be further adjusted. Specifically, the first model may be trained again through transfer learning by using the preset real image dataset, to obtain the feature extraction model.

In the image encoding method provided by some exemplary embodiments, the to-be-trained model is trained by using the image texture dataset, to obtain the first model; and the first model is trained again by using the real image dataset, to obtain the feature extraction model. Therefore, the feature extraction model can effectively extract the image feature information of the to-be-encoded image, and further, the encoding parameter can be set based on the image feature information. This simplifies an image encoding procedure, and improves efficiency and accuracy of image encoding.

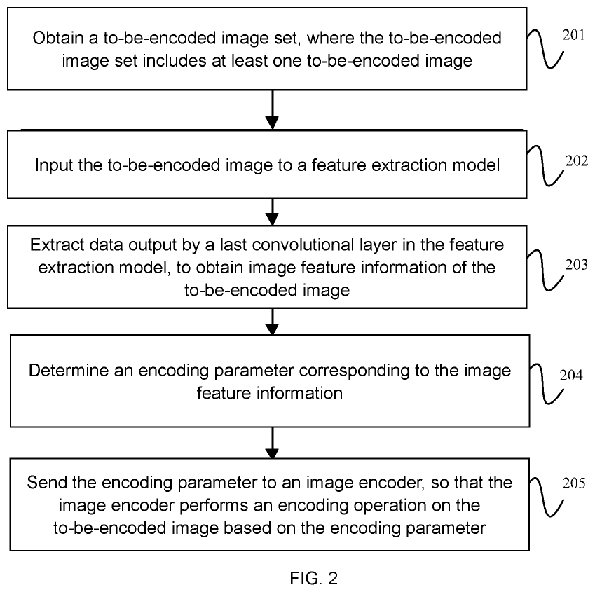

FIG. 2 is a schematic flowchart of an image encoding method according to some exemplary embodiments of the present disclosure. As shown in FIG. 2, the method may include the following steps.

Step 201: Obtain a to-be-encoded image set, where the to-be-encoded image set includes at least one to-be-encoded image.

Step 202: Input the to-be-encoded image to a feature extraction model.

Step 203: Extract data output by a last convolutional layer in the feature extraction model, to obtain image feature information of the to-be-encoded image.

Step 204: Determine an encoding parameter corresponding to the image feature information.

Step 205: Send the encoding parameter to an image encoder, so that the image encoder performs an encoding operation on the to-be-encoded image based on the encoding parameter.

In some exemplary embodiments, to improve efficiency of image feature information extraction, after the to-be-encoded image is input to the feature extraction model, the data output by the last convolutional layer in the feature extraction model may be directly extracted, and the data output by the last convolutional layer in the feature extraction model is used as the image feature information of the to-be-encoded image. By using the data output by the last convolutional layer in the feature extraction model as the image feature information of the to-be-encoded image, there is no need to go through a fully connected layer, there is no need to limit a size of input, and feature extraction can be directly performed on images of various sizes.

It should be noted that in a process of training the feature extraction model, the fully connected layer is required, but the fully connected layer may not be required in a process of applying the feature extraction model.

In the image encoding method provided by some exemplary embodiments, the to-be-encoded image is input to the feature extraction model; and the data output by the last convolutional layer in the feature extraction model is then extracted to obtain the image feature information of the to-be-encoded image. Therefore, efficiency of extracting the feature information of the to-be-encoded image can be effectively improved, which provides the basis for improving efficiency of encoding the to-be-encoded image.

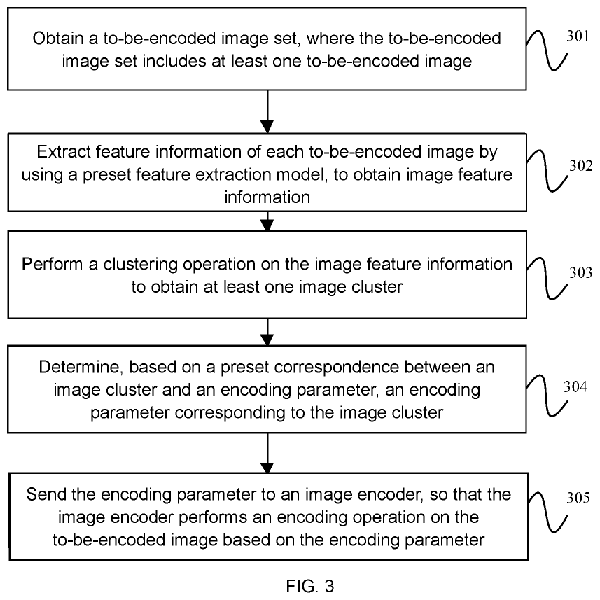

FIG. 3 is a schematic flowchart of an image encoding method according to some exemplary embodiments of the present disclosure. As shown in FIG. 3, the method may include the following steps.

Step 301: Obtain a to-be-encoded image set, where the to-be-encoded image set includes at least one to-be-encoded image.

Step 302: Extract feature information of each to-be-encoded image by using a preset feature extraction model, to obtain image feature information.

Step 303: Perform a clustering operation on the image feature information to obtain at least one image cluster.

Step 304: Determine, based on a preset correspondence between an image cluster and an encoding parameter, an encoding parameter corresponding to the image cluster.

Step 305: Send the encoding parameter to an image encoder, so that the image encoder performs an encoding operation on the to-be-encoded image based on the encoding parameter.

In some exemplary embodiments, after the image feature information of each to-be-encoded image in the to-be-encoded image set is extracted, a plurality of pieces of image feature information corresponding to the to-be-encoded images may be obtained. Because image feature information corresponding to similar images is similar, image encoding can be performed on similar images by using a same encoding parameter. Therefore, at least one similar image cluster may be determined first. For each similar image cluster, an encoding parameter corresponding to the image cluster may be preset for the image cluster. An optimum encoding effect can be achieved by using the encoding parameter. Specifically, the clustering operation may be performed on the image feature information to obtain the at least one image cluster. The encoding parameter corresponding to the image cluster may be determined based on a preset correspondence between the image cluster and the encoding parameter. After the encoding parameter corresponding to the image cluster is determined, the encoding parameter may be sent to the image encoder, so that the image encoder may perform image encoding on the to-be-encoded image based on the encoding parameter. Since an optimum encoding effect can be achieved by encoding by using the encoding parameter, encoding accuracy can be improved on a basis of improving image encoding efficiency. Any clustering mode may be used herein to implement clustering of the image feature information, and this is not limited in the present disclosure.

In the image encoding method provided by some exemplary embodiments, the at least one image cluster may be obtained by performing the clustering operation on the image feature information, and the encoding parameter corresponding to the image cluster is determined based on the preset correspondence between the image cluster and the encoding parameter. Therefore, the encoding parameter corresponding to the to-be-encoded image can be accurately determined, and encoding accuracy can be improved on a basis of improving image encoding efficiency.

Further, according to some exemplary embodiments, the method may include:

obtaining a to-be-encoded image set, where the to-be-encoded image set includes at least one to-be-encoded image;

extracting feature information of each to-be-encoded image by using a preset feature extraction model, to obtain image feature information;

performing a vectorized representation on the image feature information to obtain a vector corresponding to the image feature information;

determining at least one image cluster based on the vector;

determining, based on a preset correspondence between an image cluster and an encoding parameter, an encoding parameter corresponding to the image cluster; and

sending the encoding parameter to an image encoder, so that the image encoder performs an encoding operation on the to-be-encoded image based on the encoding parameter.

In some exemplary embodiments, the clustering of the image feature information may be implemented by using the vector corresponding to the image feature information. Specifically, to implement the clustering of the image feature information, firstly it is necessary to perform the vectorized representation on the image feature information to obtain the vector corresponding to the image feature information. It should be noted that any vectorized representation method may be used herein to implement the vectorized representation of the image feature information, and this is not limited in the present disclosure. After the vector of the image feature information is obtained, the at least one image cluster may be determined based on the vector of the image feature information.

In the image encoding method provided by some exemplary embodiments, the vectorized representation is performed on the image feature information to obtain the vector corresponding to the image feature information; and the at least one image cluster is determined based on the vector. Therefore, the clustering of the image feature information can be implemented accurately, which can provide a basis for subsequent image encoding.

Further, according to some exemplary embodiments, the image feature information may include at least one piece of image sub-feature information, and the method may include:

obtaining a to-be-encoded image set, where the to-be-encoded image set includes at least one to-be-encoded image;

extracting feature information of each to-be-encoded image by using a preset feature extraction model, to obtain image feature information;

performing a vectorized representation on the image feature information by using a fisher-vector algorithm, to obtain vector information corresponding to the image feature information;

determining the at least one image cluster based on the vector;

determining, based on a preset correspondence between an image cluster and an encoding parameter, an encoding parameter corresponding to the image cluster; and

sending the encoding parameter to an image encoder, so that the image encoder performs an encoding operation on the to-be-encoded image based on the encoding parameter.

In some exemplary embodiments, the fisher vector algorithm may be used to implement the vectorized representation of the image feature information. Specifically, after features of the to-be-encoded image are extracted, the image feature information is obtained. The image feature information includes at least one piece of image sub-feature information. The image may be expressed as: X={xₜ, t=1, 2, . . . , T}, where xₜ indicates each piece of image sub-feature information, which approximately satisfies independent identical distribution. Firstly a linear combination model including at least one Gaussian distribution and corresponding to the image feature information needs to be established, as represented by a formula 1 and a formula 2 shown below:

$$\begin{matrix}p ( {x}_{t} \vert λ ) = {\sum }_{i - 1}^{K} {w}_{i} {p}_{i} ( {x}_{i} \vert λ ) & ( 1 ) \\ {p}_{i} ( x \vert λ ) = \frac{exp \{ - \frac{1}{2} {( x - {μ}_{i} )}^{T} {\sum }_{i}^{- 1} ( x - {μ}_{i} ) \}}{{( 2 π )}^{\frac{D}{2}} {\vert {\sum }_{i} \vert}^{\frac{1}{2}}} & ( 2 )\end{matrix}$$

where Pᵢ indicates a Gaussian distribution, w indicates a combination coefficient

$${\sum }_{i = 1}^{K} {w}_{i} = 1 ,$$

D indicates a feature vector dimension, μ and σ indicate an average value and a standard deviation of the Gaussian distribution respectively, and

$${\vert {\sum }_{i} \vert}^{\frac{1}{2}}$$

is a standard deviation of an ith Gaussian model.

The image feature information includes at least one piece of image sub-feature information. Therefore, after the linear combination model is established, probability information of each image sub-feature belonging to each Gaussian distribution may be calculated. Specifically, calculation of the probability information may be implemented based on a formula 3 shown below:

$${γ}_{t} ( i ) = \frac{{w}_{i} {p}_{i} ( {x}_{t} )}{{\sum }_{k = 1}^{K} {w}_{k} {p}_{k} ( {x}_{t} )} \qquad ( 3 )$$

Partial derivatives are obtained for the preset combination coefficient, the average value, and the standard deviation respectively based on the linear combination model and the probability information, and vectors corresponding to the preset combination coefficient, the average value, and the standard deviation are then obtained, as shown in a formula 4 shown below:

$${ζ}_{{w}_{k}}^{X} = \frac{1}{\sqrt{{w}_{k}}} {\sum }_{t = 1}^{T} ( {γ}_{t} ( k ) - {w}_{k} ) \\ {ζ}_{{μ}_{k}}^{X} = \frac{1}{\sqrt{{w}_{k}}} {\sum }_{t = 1}^{T} {γ}_{t} ( k ) ( \frac{{x}_{t} - {μ}_{k}}{{σ}_{k}} ) \\ {ζ}_{{σ}_{k}}^{X} = \frac{1}{\sqrt{{w}_{k}}} {\sum }_{t = 1}^{T} {γ}_{t} ( k ) \frac{1}{\sqrt{2}} ( \frac{{( {x}_{t} - {μ}_{k} )}^{2}}{{σ}_{k}^{2}} - 1 ) \qquad ( 4 )$$

After the vectors corresponding to the preset combination coefficient, the average value, and the standard deviation are obtained, the vectors corresponding to the preset combination coefficient, the average value, and the standard deviation may be normalized, and then vector information corresponding to the image feature information may be obtained. Further, the image feature information may be clustered and the encoding parameter may be determined based on the vector information.

In the image encoding method provided by some exemplary embodiments, the linear combination model including the at least one Gaussian distribution and corresponding to the image feature information is established; the probability information of a piece of image sub-feature information belonging to each Gaussian distribution is calculated; the partial derivatives are then obtained for the preset combination coefficient, the average value and the standard deviation respectively based on the linear combination model and the probability information, the vectors corresponding to the preset combination coefficient, the average value and the standard deviation are obtained; and the vectors corresponding to the preset combination coefficient, the average value and the standard deviation are then normalized, so as to obtain the vector information corresponding to the image feature information. Therefore, the vector information corresponding to the image feature information can be obtained accurately through calculation. Further, the image feature information may be clustered and the encoding parameter may be determined based on the vector information. This provides a basis for improving the efficiency of image encoding.

Further, according to some exemplary embodiments, the method may include:

obtaining a to-be-encoded image set, where the to-be-encoded image set includes at least one to-be-encoded image;

extracting feature information of each to-be-encoded image by using a preset feature extraction model, to obtain image feature information;

performing a vectorized representation on the image feature information to obtain a vector corresponding to the image feature information;

determining at least one image cluster based on the vector information by using a classification method of unsupervised learning;

determining, based on a preset correspondence between an image cluster and an encoding parameter, an encoding parameter corresponding to the image cluster; and

sending the encoding parameter to an image encoder, so that the image encoder performs an encoding operation on the to-be-encoded image based on the encoding parameter.

In some exemplary embodiments, the image feature information may be classified into at least one image cluster based on a similarity and difference of the image feature information. Specifically, the classification method of unsupervised learning may be used to perform an image clustering operation.

The classification method of unsupervised learning may include at least one of a prototype clustering algorithm, a hierarchical clustering algorithm, a density clustering algorithm, or an expectation-maximum algorithm (EM algorithm for short).

In the image encoding method provided by some exemplary embodiments, the at least one image cluster may be determined based on the vector information by using the classification method of unsupervised learning. Therefore, the clustering of the image feature information can be implemented, which provides a basis for subsequently improving image encoding efficiency.

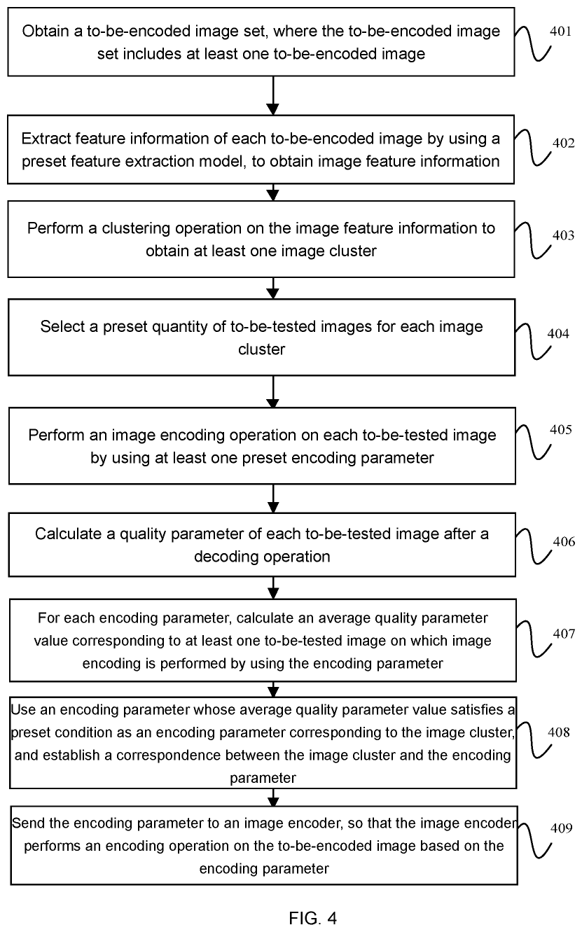

FIG. 4 is a schematic flowchart of an image encoding method according to some exemplary embodiments of the present disclosure. As shown in FIG. 4, the method may include the following steps.

Step 401: Obtain a to-be-encoded image set, where the to-be-encoded image set includes at least one to-be-encoded image.

Step 402: Extract feature information of each to-be-encoded image by using a preset feature extraction model, to obtain image feature information.

Step 403: Perform a clustering operation on the image feature information to obtain at least one image cluster.

Step 404: Select a preset quantity of to-be-tested images for each image cluster.

Step 405: Perform an image encoding operation on each to-be-tested image by using at least one preset encoding parameter.

Step 406: Calculate a quality parameter of each to-be-tested image after a decoding operation.

Step 407: For each encoding parameter, calculate an average quality parameter value corresponding to at least one to-be-tested image on which image encoding is performed by using the encoding parameter.

Step 408: Use an encoding parameter whose average quality parameter value satisfies a preset condition as an encoding parameter corresponding to the image cluster, and establish a correspondence between the image cluster and the encoding parameter.

Step 409: Send the encoding parameter to an image encoder, so that the image encoder performs an encoding operation on the to-be-encoded image based on the encoding parameter.

In some exemplary embodiments, after the at least one image cluster is obtained, for each image cluster, a corresponding encoding parameter may be set for the image cluster, so that image encoding may be subsequently performed based on the encoding parameter. Specifically, a plurality of groups of encoding parameters may be summarized based on historical experience, and each group may include at least one encoding parameter. In addition, a preset quantity of to-be-tested images may be selected from each image cluster. For each to-be-tested image, the to-be-tested image may be encoded by using at least one preset encoding parameter. A decoding operation may be then performed on the encoded to-be-tested image; a quality parameter of the to-be-tested image following the decoding may be calculated; for each encoding parameter, an average quality parameter value of the to-be-tested image on which encoding is performed by using the encoding parameter is then calculated; an encoding parameter whose average quality parameter value satisfies the preset condition may be used as the encoding parameter corresponding to the image cluster, and a correspondence between the image cluster and the encoding parameter is then established. In an actual application, the preset condition that the quality parameter needs to satisfy may be adjusted based on an actual requirement. For example, the preset condition may be using an encoding parameter with a highest quality parameter as the encoding parameter corresponding to the image cluster. The preset condition may also be using an encoding parameter with a lowest quality parameter as the encoding parameter corresponding to the image cluster. This is not limited in the present disclosure. When a to-be-encoded image is received subsequently, a vectorized representation is performed on the to-be-encoded image. After an image cluster to which the to-be-encoded image belongs is determined, the encoding parameter may be obtained directly based on the correspondence. Therefore, efficiency of obtaining the encoding parameter can be improved, and in addition, accuracy of image encoding can be further improved. In the image encoding method provided by some exemplary embodiments, the preset quantity of to-be-tested images may be selected for each image cluster; the image encoding operation is performed on each to-be-tested image by using the at least one preset encoding parameter; the quality parameter of each to-be-tested image after the decoding operation is then calculated; for each encoding parameter, the average quality parameter value corresponding to the at least one to-be-tested image on which image encoding is performed by using the encoding parameter may be calculated; an encoding parameter whose average quality parameter value is the largest is used as the encoding parameter corresponding to the image cluster, and a correspondence between the image cluster and the encoding parameter is then established. Therefore, the encoding parameter can be obtained quickly, and efficiency and accuracy of image encoding are improved.

Further, according to some exemplary embodiments, the using od the encoding parameter whose average quality parameter value satisfies a preset condition as an encoding parameter corresponding to the image cluster, and the establishing of the correspondence between the image cluster and the encoding parameter may include:

Using an encoding parameter whose average quality parameter value is the largest as the encoding parameter corresponding to the image cluster, and then establishing the correspondence between the image cluster and the encoding parameter.

In some exemplary embodiments, if the average quality parameter value is relatively large, it indicates that the image cluster is suitable for being encoded by using the encoding parameter. Therefore, the encoding parameter whose average quality parameter value is the largest (that is, the encoding parameter with the largest average quality parameter value) may be used as the encoding parameter corresponding to the image cluster, thus the correspondence between the image cluster and the encoding parameter is established. When a to-be-encoded image is received subsequently, a vectorized representation may be performed on the to-be-encoded image. After an image cluster to which the to-be-encoded image belongs is determined, the encoding parameter may be obtained directly based on the correspondence. Therefore, efficiency of obtaining the encoding parameter can be improved, and in addition, accuracy of image encoding can be further improved.

In the image encoding method provided by some exemplary embodiments, the encoding parameter whose average quality parameter value is largest may be used as the encoding parameter corresponding to the image cluster, and the correspondence between the image cluster and the encoding parameter is then established. Therefore, the efficiency for obtaining the encoding parameter can be improved.

It should be noted that the quality parameter may include at least one of a peak signal to noise ratio of the to-be-tested image before and after decoding, structural consistency of the to-be-tested image before and after decoding and a mean square error of the to-be-tested image before and after decoding. By using at least one of the peak signal to noise ratio of the to-be-tested image before and after decoding, the structural consistency of the to-be-tested image before and after decoding, and the mean square error of the to-be-tested image before and after decoding as the quality parameter, an encoding parameter most suitable for the image cluster may be accurately determined, and accuracy of image encoding is further improved.

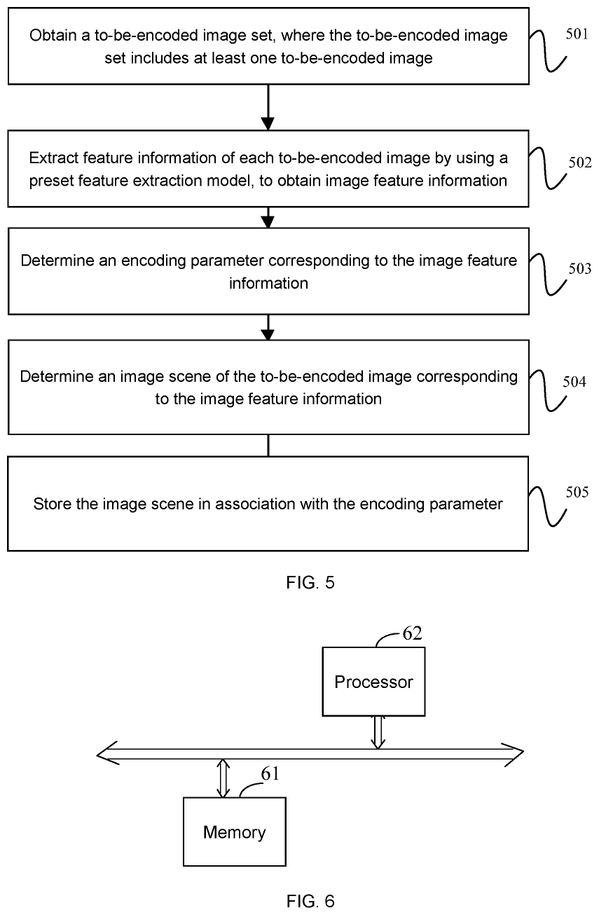

FIG. 5 is a schematic flowchart of an image encoding method according to some exemplary embodiments of the present disclosure. As shown in FIG. 5, the method may include the following steps.

Step 501: Obtain a to-be-encoded image set, where the to-be-encoded image set includes at least one to-be-encoded image.

Step 502: Extract feature information of each to-be-encoded image by using a preset feature extraction model, to obtain image feature information.

Step 503: Determine an encoding parameter corresponding to the image feature information.

Step 504: Determine an image scene of the to-be-encoded image corresponding to the image feature information.

Step 505: Store the image scene in association with the encoding parameter.

In some exemplary embodiments, for different requirements and application scenarios, different image encoding modes may be used respectively. For example, the image encoding modes may specifically include an online encoding mode and an offline encoding mode. When the online encoding mode is used, features of the to-be-encoded image may be firstly extracted, to obtain the image feature information corresponding to the to-be-encoded image; an image cluster to which the image feature information belongs is determined, an encoding parameter is then determined based on a preset correspondence between an image cluster and an encoding parameter; and the encoding parameter is then sent to an image encoder, so that the image encoder performs image encoding on the to-be-encoded image based on the encoding parameter. When the offline encoding mode is used, image feature information corresponding to a plurality of to-be-encoded images may be firstly extracted; an image cluster to which the image feature information belongs is determined, and an encoding parameter is determined based on a preset correspondence between an image cluster and an encoding parameter; next, an image scene to which a to-be-encoded image of each image cluster belongs is determined, and a correspondence between the image scene and the encoding parameter is then established, where the image scene includes, but is not limited to, a rainy scene, a mountainous scene, an urban scene, or the like. Therefore, after the to-be-encoded image is received, the image scene to which the to-be-encoded image belongs may be determined, and the encoding parameter required by the current to-be-encoded image may then be determined based on the correspondence between the image scene and the encoding parameter. Further, the image encoder may encode the to-be-encoded image based on the encoding parameter.

In the image encoding method provided by some exemplary embodiments, an image scene of the to-be-encoded image corresponding to each image cluster is determined, and the image scene is stored in association with the encoding parameter. Therefore, offline encoding can be implemented, and efficiency of image encoding is further improved.

Further, according to some exemplary embodiments, the method may include:

obtaining a to-be-encoded image set, where the to-be-encoded image set includes at least one to-be-encoded image;

determining an image scene corresponding to the to-be-encoded image in the to-be-encoded image set;

obtaining an encoding parameter corresponding to the image scene; and

sending the encoding parameter to an image encoder, so that the image encoder performs an encoding operation on the to-be-encoded image based on the encoding parameter.

In some exemplary embodiments, after a correspondence between the image scene and the encoding parameter of the to-be-encoded image is determined, the to-be-encoded image may be encoded based on the correspondence. The correspondence may be built in the image encoder, or may be set in a physical apparatus independent of the image encoder. This is not limited in the present disclosure. Specifically, after the to-be-encoded image set is received, the image scene corresponding to the to-be-encoded image in the to-be-encoded image set may be firstly determined; the encoding parameter corresponding to the image scene is then obtained; and the encoding parameter is sent to the image encoder, so that the image encoder may encode the to-be-encoded image based on the encoding parameter.

In the image encoding method provided by some exemplary embodiments, the image scene corresponding to the to-be-encoded image in the to-be-encoded image set is determined; the encoding parameter corresponding to the image scene is obtained; and the encoding parameter is sent to the image encoder, so that the image encoder performs the encoding operation on the to-be-encoded image based on the encoding parameter. Therefore, offline encoding can be implemented, and efficiency of image encoding is further improved.

Further, according to some exemplary embodiments, the feature information of the to-be-encoded image may be texture information of the to-be-encoded image.

In some exemplary embodiments, the texture information of the image is a visual feature that reflects a homogeneity phenomenon in the image. The texture information reflects an intrinsic property shared by surfaces of objects, and contains important information about surface structures and organization arrangements of the objects and an association between them and a surrounding environment. The texture information has three major signs: continuous repetition of a partial sequence, a non-random arrangement, and a roughly uniform unity in a texture region. Therefore, the texture information may contain rich and specific image information, which can describe content of the image well, so that the texture information of the image may be used as the feature information of the to-be-encoded image.

In the image encoding method provided by some exemplary embodiments, the texture information of the to-be-encoded image may be used as the feature information of the to-be-encoded image, so that accuracy of extracting the features of the to-be-encoded image can be improved. This provides a basis for subsequent clustering and encoding of the to-be-encoded image.

Further, according to some exemplary embodiments, the encoding parameter may include at least one of a typical quantization parameter design, a quantization table design, a feature transformation accuracy design, or a ratio design of rate control.

FIG. 6 is a schematic structural diagram of an image encoding device according to some exemplary embodiments of the present disclosure. As shown in FIG. 6, the device may include at least one memory 61 and at least one processor 62,

the at least one memory 61 is configured to store program code or a set of instructions; and

the at least one processor 62 is in communication with the at least one memory, and configured, during operation, to invoke the program code, and configured to perform the following operations when the program code or the set of instructions is executed:

obtaining a to-be-encoded image set, where the to-be-encoded image set includes at least one to-be-encoded image;

extracting feature information of each to-be-encoded image by using a preset feature extraction model, to obtain image feature information;

determining an encoding parameter corresponding to the image feature information; and

sending the encoding parameter to an image encoder, so that the image encoder performs an encoding operation on the to-be-encoded image based on the encoding parameter.

The image encoding device provided by some exemplary embodiments may obtain the to-be-encoded image set, where the to-be-encoded image set includes the at least one to-be-encoded image; extract the feature information of each to-be-encoded image by using the preset feature extraction model, to obtain the image feature information; determine the encoding parameter corresponding to the image feature information; and send the encoding parameter to the image encoder, so that the image encoder performs the encoding operation on the to-be-encoded image based on the encoding parameter. Therefore, the to-be-encoded image may be automatically encoded, image encoding efficiency is effectively improved, and human resources can be saved.

Further, on a basis of some foregoing exemplary embodiments, prior to extracting the feature information of the to-be-encoded image by using the preset feature extraction model, the processor may be further configured to:

train a preset to-be-trained model by using a preset to-be-trained image set, to obtain the feature extraction model.

Further, on a basis of some of the foregoing exemplary embodiments, the to-be-trained image set may include an image texture dataset and a real image dataset.

Further, on a basis of some foregoing exemplary embodiments, for training the preset to-be-trained model by using the preset to-be-trained image set, the processor may be configured to:

train the to-be-trained model by using the image texture dataset, to obtain a first model; and

train the first model again by using the real image dataset, to obtain the feature extraction model.

Further, on a basis of some foregoing exemplary embodiments, for extracting the feature information of the to-be-encoded image by using the preset feature extraction model, to obtain the image feature information, the processor may be configured to:

input the to-be-encoded image to the feature extraction model; and

extract data output by a last convolutional layer in the feature extraction model, to obtain the feature information of the to-be-encoded image.

Further, on a basis of some foregoing exemplary embodiments, for determining the encoding parameter corresponding to the image feature information, the processor may be configured to:

perform a clustering operation on the image feature information to obtain at least one image cluster; and

determine, based on a preset correspondence between an image cluster and an encoding parameter, an encoding parameter corresponding to the image cluster.

Further, on a basis of some foregoing exemplary embodiments, for performing the clustering operation on the image feature information to obtain the at least one image cluster, the processor may be configured to:

perform a vectorized representation on the image feature information to obtain a vector corresponding to the image feature information; and

determine the at least one image cluster based on the vector.

Further, on a basis of some foregoing exemplary embodiments, the image feature information may include at least one piece of image sub-feature information, and for performing the vectorized representation on the image feature information to obtain the vector information corresponding to the image feature information, the processor may be configured to:

perform the vectorized representation on the image feature information by using a fisher-vector algorithm, to obtain vector information corresponding to the image feature information.

Further, on a basis of some foregoing exemplary embodiments, for determining the at least one image cluster based on the vector information, the processor may be configured to:

determine the at least one image cluster based on the vector information by using a classification method of unsupervised learning.

Further, on a basis of some foregoing exemplary embodiments, the classification method of unsupervised learning may include at least one of the following:

a prototype clustering algorithm, a hierarchical clustering algorithm, a density clustering algorithm, or an expectation-maximum algorithm.

Further, on a basis of any one of the foregoing exemplary embodiments, for determining, based on the preset correspondence between the image cluster and the encoding parameter, the encoding parameter corresponding to the image cluster, the processor may be configured to:

select a preset quantity of to-be-tested images for each image cluster;

perform an image encoding operation on each to-be-tested image by using at least one preset encoding parameter;

calculate a quality parameter of each to-be-tested image after a decoding operation;

for each encoding parameter, calculate an average quality parameter value corresponding to at least one to-be-tested image on which image encoding is performed by using the encoding parameter; and

use an encoding parameter whose average quality parameter value satisfies a preset condition as the encoding parameter corresponding to the image cluster, and establish a correspondence between the image cluster and the encoding parameter.

Further, on a basis of some foregoing exemplary embodiments, for using the encoding parameter whose average quality parameter value satisfies the preset condition as the encoding parameter corresponding to the image cluster, and establishing the correspondence between the image cluster and the encoding parameter, the processor may be configured to:

use an encoding parameter whose average quality parameter value is largest as the encoding parameter corresponding to the image cluster, and establish a correspondence between the image cluster and the encoding parameter.

Further, on a basis of some foregoing exemplary embodiments, the quality parameter may include at least one of a peak signal to noise ratio of the to-be-tested image, structural consistency of the to-be-tested image before and after decoding, or a mean square error of the to-be-tested image before and after decoding.

Further, on a basis of some foregoing exemplary embodiments, after determining the encoding parameter corresponding to the image feature information, the processor may be further configured to:

determine an image scene of the to-be-encoded image corresponding to the image feature information; and

store the image scene in association with the encoding parameter.

Further, on a basis of some foregoing exemplary embodiments, after obtaining the to-be-encoded image set, the processor may be further configured to:

determine the image scene corresponding to the to-be-encoded image in the to-be-encoded image set;

obtain the encoding parameter corresponding to the image scene; and

send the encoding parameter to the image encoder, so that the image encoder performs the encoding operation on the to-be-encoded image based on the encoding parameter.

Further, on a basis of some foregoing exemplary embodiments, the feature information of the to-be-encoded image may be texture information of the to-be-encoded image.

Further, on a basis of some foregoing embodiments, the encoding parameter may include at least one of a typical quantization parameter design, a quantization table design, a feature transformation accuracy design, or a ratio design of bit rate control.

In addition, some exemplary embodiments may further provide a computer-readable storage medium, where the computer-readable storage medium may store a computer program, and the computer program may be executed by at least one processor to implement the image encoding method set forth in the foregoing embodiments.

In some exemplary embodiments provided in the present disclosure, it should be understood that the disclosed apparatus and method may be implemented in other manners. For example, the device embodiments described above are only illustrative. For example, a unit division is merely a logical function division, and there may be other types of divisions in actual implementation. For example, a plurality of units or components may be combined or integrated into another system, or some features may be ignored or may not be performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described herein as separate parts may or may not be physically separate; parts displayed as units may or may not be physical units, may be located in one position, or may be distributed on a plurality of network elements. Some or all of the units may be selected based on actual requirements to achieve the objects of the solutions of the embodiments.

In addition, functional units in the embodiments of the present disclosure may be integrated into one processing unit, or each of the units may exist alone physically, or two or more units are integrated into one unit. The integrated unit may be implemented in a form of hardware, or may be implemented in a form of hardware in addition to a software functional unit.

When the foregoing integrated unit is implemented in a form of a software functional unit, the integrated unit may be stored in a computer-readable storage medium. The software functional unit may be stored in a storage medium and include several instructions for instructing a computer device (which may be a personal computer, a server, a network device, or the like) or a processor to perform a part of the steps of the methods described in the embodiments of the present disclosure. The foregoing storage medium may include: any medium that can store program code, such as a USB flash drive, a removable hard disk, a read-only memory (ROM), a random access memory (RAM), a magnetic disk, or an optical disc.

It will be appreciated by a person skilled in the art that, for the purpose of convenient and brief description, division of the foregoing functional modules is used as an example for illustration. In an actual application, the foregoing functions may be allocated to different functional modules and implemented as needed, that is, an internal structure of the apparatus may be divided into different functional modules to implement all or a part of the functions described above. For a detailed working process of the foregoing apparatus, reference may be made to a corresponding process in the method embodiments, and details are not described again herein.

Finally, it should be noted that the foregoing exemplary embodiments are merely intended for describing the technical solutions of the present disclosure, but not for limiting the present disclosure. Although the present disclosure is described in detail with reference to the foregoing exemplary embodiments, a person of ordinary skill in the art should understand that modifications may be made to the technical solutions described in the the exemplary embodiments or equivalent replacements may be made to some or all technical features thereof, without departing from the scope of the technical solutions of the embodiments of the present disclosure.

What is claimed is:

1. An image encoding method, comprising:
obtaining a to-be-encoded image set, wherein the to-be-encoded image set includes at least one to-be-encoded image;
for a to-be-encoded image of the at least one to-be-encoded image:
extracting image feature information of the to-be-encoded image using a preset feature extraction model;
determining an encoding parameter corresponding to the image feature information; and
sending the encoding parameter to an image encoder to encode the to-be-encoded image based on the encoding parameter.

2. The method according to claim 1, wherein prior to the extracting of the feature information of the to-be-encoded image, the method further includes:
training a preset to-be-trained model by using a preset to-be-trained image set to obtain the preset feature extraction model.

3. The method according to claim 2, wherein the preset to-be-trained image set includes an image texture dataset and a real image dataset.

4. The method according to claim 3, wherein the training of the preset to-be-trained model includes:
training the preset to-be-trained model by using the image texture dataset to obtain a first model; and
training the first model by using the real image dataset to obtain the feature extraction model.

5. The method according to claim 1, wherein the extracting of the feature information of the to-be-encoded image includes:
inputting the to-be-encoded image to the preset feature extraction model; and
extracting data output by a last convolutional layer in the preset feature extraction model to obtain the feature information of the to-be-encoded image.

6. The method according to claim 1, wherein the determining of the encoding parameter corresponding to the image feature information includes:
performing a clustering operation on the image feature information to obtain at least one image cluster; and
determining the encoding parameter based on a preset correspondence between image clusters and encoding parameters.

7. The method according to claim 6, wherein the performing of the clustering operation on the image feature information to obtain the at least one image cluster includes:
performing a vectorized representation on the image feature information to obtain a vector corresponding to the image feature information; and
determining the at least one image cluster based on the vector.

8. The method according to claim 7, wherein the performing of the vectorized representation on the image feature information to obtain the vector corresponding to the image feature information includes:
performing the vectorized representation on the image feature information by using a fisher-vector algorithm to obtain the vector corresponding to the image feature information.

9. The method according to claim 7, wherein the determining of the at least one image cluster based on the vector includes:
determining the at least one image cluster based on the vector by using a classification method of unsupervised learning.

10. The method according to claim 9, wherein the classification method of unsupervised learning includes at least one of:
a prototype clustering algorithm, a hierarchical clustering algorithm, a density clustering algorithm, or an expectation-maximum algorithm.

11. The method according to claim 6, wherein the determining of the encoding parameter based on a preset correspondence between image clusters and encoding parameters includes:
selecting a preset quantity of to-be-tested images from one of the at least one image cluster;
encoding the preset quantity of to-be-tested images with a set of preset encoding parameters;
calculating quality parameters of the preset quantity of to-be-tested images after decoding;
calculating an average quality parameter value of the preset quantity of to-be-tested images for each preset encoding parameter in the preset encoding parameter to obtain a set of average quality parameter values corresponding to the set of preset encoding parameters; and
selecting a preset encoding parameter with an average quality parameter value satisfying a preset condition from the set of preset encoding parameters as the encoding parameter.

12. The method according to claim 11, wherein the selecting of the preset encoding parameter with the average quality parameter value satisfying the preset condition from the set of preset encoding parameters as the encoding parameter includes:
selecting the preset encoding parameter with the largest average quality parameter value from the set of preset encoding parameters as the encoding parameter.

13. The method according to claim 11, wherein the preset quality parameters include at least one of:
peak signal to noise ratios of the to-be-tested images before and after the decoding,
structural consistencies of the to-be-tested images before and after the decoding, or
mean square errors of the to-be-tested images before and after the decoding.

14. The method according to claim 1, further comprising: for the to-be-encoded image of the at least one to-be-encoded image:
determining an image scene of the to-be-encoded image corresponding to the image feature information after the determining of the encoding parameter corresponding to the image feature information; and
storing the image scene in association with the encoding parameter.

15. The method according to claim 14, further comprising:
determining, after obtaining the to-be-encoded image set, the image scene corresponding to the at least one to-be-encoded image in the to-be-encoded image set;
obtaining the encoding parameter corresponding to the image scene; and
sending the encoding parameter to the image encoder, so that the image encoder performs the encoding operation on the to-be-encoded image based on the encoding parameter.

16. The method according to claim 1, wherein the feature information is texture information of the to-be-encoded image.

17. The method according to claim 1, wherein the encoding parameter includes at least one parameter of a typical quantization parameter design, a quantization table design, a feature transformation accuracy design, or a rate control ratio design.

18. An image encoding device, comprising:
at least one memory storing a set of instructions for image encoding; and
at least one processor in communication with the at least one memory, wherein during operation, the at least one processor executes the set of instructions to:
obtain a to-be-encoded image set, wherein the to-be-encoded image set includes at least one to-be-encoded image;
for a to-be-encoded image of the at least one to-be-encoded image:
extract image feature information of each the to-be-encoded image using a preset feature extraction model;
determine an encoding parameter corresponding to the image feature information; and
send the encoding parameter to the image encoder to encoding the to-be-encoded image based on the encoding parameter.

19. The image encoding device according to claim 18, wherein the determining of the encoding parameter corresponding to the image feature information includes:
performing a clustering operation on the image feature information to obtain at least one image cluster; and
determining the encoding parameter based on a preset correspondence between image clusters and encoding parameters.

20. A non-transitory computer-readable storage medium, wherein
the computer-readable storage medium stores a set of instructions for image encoding; and
wherein when executed by at least one processor, the set of instruction direct the at least one processor to perform:
obtaining a to-be-encoded image set, wherein the to-be-encoded image set includes at least one to-be-encoded image,
for a to-be-encoded image of the at least one to-be-encoded image:
extracting image feature information of the to-be-encoded image using a preset feature extraction mode,
determining an encoding parameter corresponding to the image feature information, and
sending the encoding parameter to an image encoder to encoding the to-be-encoded image based on the encoding parameter.
